(19) United States
(12) Patent Application Publication
(10) Pub. No.: US 2005/0036905 A1
(43) Pub. Date: Feb. 17, 2005

(54) Defect controlled nanotube sensor and method of production

(75) Inventor: Halit Suha Gokturk, Mountain View, CA (US)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 10/638,483

(22) Filed: Aug. 12, 2003

(51) Int. Cl. G01N 1/00

(52) U.S. Cl. 422/55

(57) ABSTRACT

Sensor for detecting a physical or chemical quantity, comprising a defect controlled nanotube. The sensor can be produced by post treating a nanotube with sufficient energy to modify at least one of density and type of defects in the nanotube, and associating the nanotube with a circuit capable of providing an output signal based upon change of electrical characteristic of the nanotube in response to stimulus of the nanotube.

### BACKGROUND OF THE INVENTION

1. Field of the Invention

The present invention is directed to nanotubes, particularly defect controlled nanotubes, and processes for forming defect controlled nanotubes which includes treatment of nanotubes, preferably post treatment of nanotubes. The present invention is also directed to processes of using, such nanotubes as sensors, and producing nanotubes, particularly defect controlled nanotubes. Moreover, the present invention is directed to apparatus, such as circuits, including nanotubes, particularly defect controlled nanotubes.

Nanotubes according to the present invention can be enhanced by introducing defects, and preferably by introducing defects into already formed nanotubes. For example, the density and/or type of defects can be changed in nanotubes in a controlled manner to provide nanotubes with a controlled density and/or types of defects depending upon the application. For example, in the case of sensors, sensitivity of nanotubes to target quantities to be measured can be increased depending upon the defects, and can increase with increasing defects. This invention is particularly applicable to sensors, such as sensors useful for mechanical, humidity, temperature and light detection and/or quantification. In particular, the present invention provides an unexpected sensitivity in sensors that permit the use of sensors with higher sensitivity and, in fact, enable detection under circumstances wherein detection was not previously possible.

2. Background of the Invention and Related Art

Nanotubes are known in the art with the preferred material of construction being carbon atoms. Moreover, various techniques are known for producing nanotubes, such as vapor chemical deposition, arc discharge, and laser ablation. See, for example, Collins et al., “Nanotubes for Electronics”, Scientific American, December 2000, pages 62-69; Stahl et al., “Intertube Coupling in Ropes of Single-Wall Carbon Nanotubes,” Physical Review Letters, Volume 85, No. 24, December 2000, pages 5186-5189, and Dai, “Carbon Nanotubes: Opportinities and Challenges”, Surface Science 500 (2002) pages 218-241, the disclosures of which are incorporated by reference herein in their entireties.

Nanotubes can comprise long slender tubes of the atoms bonded to each other to thereby achieve high resilience, tensile strength and thermal stability. Nanotubes can be single wall (SWT) or multiple wall (MWT) such as wherein nanotubes are positioned one within the other. Moreover, nanotubes may be metallic or semiconductors. The metallic or semiconductor nature of the nanotubes is considered to primarily depend upon the configuration of the atoms within the nanotube, and can be affected by parameters such as the diameter of the nanotube. The metallic or semiconductor nature of nanotubes permits nanotubes to be useful in electrical circuits, such as sensors.

Defects are known to exist in nanotubes, such as disclosed in Crespi et al., “In Situ Band Gap Engineering of Carbon Nanotubes,”₃ Physical Review Letters, Vol. 79, No. 11, September 1997, pages 2093-2096. However, such disclosure of defects is general in nature, and does not relate to sensors and control of nanotubes for use in sensors.

Nanotubes have properties that can vary with mechanical deformation. See, Tombler et al., “Reversible Electromechanical Characteristics of Carbon Nanotubes Under Local-Probe Manipulation,” Nature, Vol. 405, June 2000, pages 769-772, the disclosure of which is incorporated by reference herein in its entirety.

Moreover, nanotubes can be utilized as sensors. For example, nanotubes can be utilized to detect physical and/or chemical parameters. See, for example, U.S. patent application Ser. No. 10/446,789, filed May 29, 2003, Japanese Patent Laid-Open Publication No. 11-241903, and Peng et al., “Ab Initio Study of Doped Carbon Nanotube Sensors,” Nano Lett., Vol. 3, No. 4, 2003, pages 513-516, the disclosures of which are incorporated by reference herein in their entireties. For example, the sensor disclosed in U.S. patent application Ser. No. 10/446,789 provides a mechanical deformation amount sensor, such as an acceleration sensor, a pressure sensor or the like, which is capable of achieving higher sensitivity than the prior art. In particular, there is provided amongst other features disclosed therein, a mechanical deformation amount sensor including a sensor structure which is formed by a semiconductor substrate or an insulating substrate and integrally includes a deformation portion deformable, when a physical quantity to be detected is applied to the sensor structure, due to the physical quantity and a support portion for supporting the deformation portion. A carbon nanotube resistance element is provided on the deformation portion so as to be mechanically deformed in response to deformation of the deformation portion. A wiring pattern is formed in a pattern on the sensor structure so as to be connected to the carbon nanotube resistance element. When a voltage is applied to the carbon nanotube resistance element via the wiring pattern, a change of electrical conductivity of the carbon nanotube resistance element upon mechanical deformation of the carbon nanotube resistance element is fetched as an electrical signal.

Moreover, nanotubes can include other atoms in combination with the primary atom, such as nitrogen or boron atoms included with the carbon atoms in carbon nanotubes. Still further, the nanotubes can be doped with materials, such as chemical moieties which can interact with materials to be analyzed.

Current pressure sensors use piezo phenomenon of silicon, and utilize the sensor as a resistance element measured in Wheatstone bridge configuration. Carbon nanotube sensors can also be used as resistance elements. However, while nanotubes are known for use in circuits and as sensors, there is still a need in the art to provide nanotubes that have greater sensitivity, greater variations in electrical characteristics and/or greater control over their characteristics.

### SUMMARY OF THE INVENTION

The present invention is directed to nanotubes, particularly carbon nanotubes.

The present invention is also directed to nanotubes including defects, and in particular, nanotubes containing defects providing enhanced performance comprising defect controlled nanotubes.

The present invention is also directed to circuits containing defect controlled nanotubes and circuits including the defect controlled nanotubes.

The present invention is also directed to sensors and circuits containing sensors wherein the sensor is composed of a defect controlled nanotube.

The invention provides a sensor for detecting at least one of a physical and chemical quantity, comprising a defect controlled nanotube providing a change in electrical characteristic responsive to at least one of a physical and chemical quantity.

The present invention also provides a sensor for detecting at least one of a physical and chemical quantity, comprising at least one post treated nanotube modified with sufficient energy to modify at least one of density and type of defects in the nanotube, and the nanotube being associated with a circuit capable of providing an output signal based upon change of electrical characteristic of the nanotube in response to stimulus of the nanotube by at least one of a physical and chemical quantity.

The sensor can include a circuit containing the defect controlled nanotube as a resistive device, such as a resistor, the defect controlled nanotube being included in the circuit so that change of resistive properties of the resistive device is related to the change in electrical characteristic responsive to at least one of a physical and chemical quantity.

The sensor can include a circuit containing the defect controlled nanotube as a capacitive device, such as a capacitor, the defect controlled nanotube being included in the circuit so that change of capacitive properties of the capacitive device is related to the change in electrical characteristic responsive to at least one of a physical and chemical quantity.

The sensor can include a circuit containing the defect controlled nanotube as a transistor device, such as a transistor, the defect controlled nanotube being included in the circuit so that change of drain to source conductance of the transistor device is related to the change in electrical characteristic responsive to at least one of a physical and chemical quantity.

The capacitor can be constructed with each electrode spaced from the defect controlled nanotube, and the defect controlled nanotube can be included in the circuit as a polarizable material.

The circuit can be constructed and arranged to apply an electric field parallel or perpendicular to the nanotube.

The sensor can detect at least one of humidity, light, temperature and strain.

The sensor can comprise a deformation sensor wherein the defect controlled nanotube being associated and deformable with a deformable support.

The defect controlled nanotube can comprise a nanotube having a length of at least 1 μm, and can comprise at least one section along the length of the nanotube that has a density of defects of at least 2 defects per 100 nm, preferably at least 2 defects per 10 nm, and even more preferably at least 2 defects per 1 nm. The defect controlled nanotube can comprise a nanotube having a length of at least 1 μm, and can preferably comprise at least 50 defects along at least one 1 μm length of the nanotube, more preferably at least 100 defects along at least one 1 μm length of the nanotube, and even more preferably at least 500 defects along at least one 1 μm length of the nanotube. The at least one 1 μm length of the nanotube can comprise substantially any 1 μm length of the nanotube.

The defect controlled nanotube can have a length less than 1 μm, and a 30% section, when normalized to a 1 μm section, comprises at least 50 defects.

The defect controlled nanotube can comprise a nanotube having a length of at least 1 μm, and the defect controlled nanotube can include one type of defect along at least one 1 μm section of the nanotube at a number of at least 5 times an average number of other defects in a same section of the nanotube, preferably at a number of at least 100 times an average number of other defects in a same section of the nanotube, and even more preferably at a density of at least 1000 times an average number of other defects in a same section of the nanotube.

The defect controlled nanotube can comprise a nanotube having a length of less than 1 μm, and the defect controlled nanotube can include one type of defect along at least one 30% section of the nanotube at a number of at least 5 times an average number of other defects in a same section of the nanotube, preferably at a number of at least 100 times an average number of other defects in a same section of the nanotube.

The sensor can have a measurable response when the nanotube is subjected to a strain of 0.01%.

The sensor can have a gauge factor of at least 100 when the nanotube is subjected to a strain of 0.01%.

The defect controlled nanotube can comprise a post treated nanotube, and the sensor can have an increased sensitivity compared to a sensor only being different in that a nanotube included therein is not post treated.

The gauge factor can be at least 100 when the nanotube is subjected to a strain of 0.01%.

The present invention is also directed to a method of producing a sensor comprising post treating a nanotube with sufficient energy to modify at least one of density and type of defects in the nanotube, and associating the nanotube with a circuit capable of providing an output signal based upon change of electrical characteristic of the nanotube in response to stimulus of the nanotube.

The nanotube can be associated with the circuit prior to or after post treatment.

The sensor can detect at least one of humidity, light, temperature and strain.

The sensor can include a defect controlled nanotube including electrodes, and at least one electrode can be spaced from the nanotube. Moreover, each electrode can be spaced from the nanotube.

The post treatment can comprise treatment with electromagnetic radiation, preferably UV radiation.

The present invention is also directed to sensors produced by methods according to the present invention.

The sensor according to the present invention can comprise a detector that detects a physical and/or chemical quantity outside of the sensor by using a detecting device including a defect controlled nanotube, with the physical quantity being output as an electrical signal; and a signal processor that converts the electrical signal output by the detecting device into data, the data indicating the physical and/or chemical quantity.

The detecting device can be a resistor comprising the defect controlled nanotube on a base film and a set of electrodes connected to both ends of the nanotube, and wherein, when a voltage is applied to the resistor, a conductivity of the resistor is output as an electrical signal, the conductivity being affected by the physical and/or chemical quantity.

The detector comprising a resistor comprising the defect controlled nanotube can be formed by a semiconductor substrate or an insulating substrate and can include a sensor structure integrally including a deformation portion deformable, when a physical quantity to be detected is applied to the sensor structure, due to the physical quantity, and a support portion for supporting the deformation portion, and the resistor can be provided on the deformation portion for detecting a deformation.

The sensor comprising a resistor comprising the defect controlled nanotube can detect light, and the sensor can be characterized by comprising a carbon nanotube of small diameter, for example, less than 1 nm, and having a low aspect ratio, for example, less than 10; broken and stabilized carbon bonds; a density of defects adjusted to obtain a bandgap which corresponds to the energy of the photons at the wavelength of interest; a transparent protection layer to prevent exposure to ambient gases; and a transparent housing which allows passage of electromagnetic radiation at the wavelength of interest.

The sensor comprising a resistor comprising the defect controlled nanotube can detect temperature, and the sensor can be characterized by comprising a semi-metallic carbon nanotube of high aspect ratio, for example, greater than 10; broken and stabilized carbon bonds; a density of defects adjusted to broaden the bandgap to several times, for example, 5 times, that of thermal energy corresponding to the temperature of interest; a protection layer with high thermal conductivity to prevent exposure to ambient gases; and an opaque housing.

The sensor comprising a resistor comprising the defect controlled nanotube can detect humidity, and the sensor can be characterized by comprising a carbon nanotube of high aspect ratio, for example, greater than 10; broken and stabilized carbon bonds; a high density of defects without compromising the integrity of the nanotube; an opaque housing to prevent exposure to light, with the housing being permeable to water molecules in the ambient atmosphere.

The detecting device can be a capacitor comprising the defect controlled nanotube on a base film and a set of electrodes at the opposing ends of the nanotube, and when a voltage is applied to the capacitor, a capacity of the capacitor is output as an electrical signal, the capacity being affected by the physical and/or chemical quantity.

The detecting device comprising a capacitor comprising the defect controlled nanotube can be formed by a semiconductor substrate or an insulating substrate and can have a sensor structure integrally including a deformation portion deformable, when a physical quantity to be detected is applied to the sensor structure, due to the physical quantity, and a support portion for supporting the deformation portion, and the capacitor can be provided on the deformation portion for detecting a deformation.

An axial direction of the capacitor can be the same as a deformation direction of the deformation portion, and a direction of an applied electric field can also be the same as the deformation direction of the deformation portion.

The axial direction of the capacitor can be the same as the deformation direction of the deformation portion, and the direction of the applied electric field can be different from the deformation direction of the deformation portion.

The sensor comprising a capacitor comprising the defect controlled nanotube can detect light, and the sensor can be characterized by comprising a carbon nanotube of small diameter, for example, less than 1 nm, and having a low aspect ratio, for example, less than 10; broken and stabilized carbon bonds; a density of defects adjusted to obtain a bandgap which corresponds to the energy of the photons at the wavelength of interest; a transparent protection layer to prevent exposure to ambient gases; and a transparent housing which allows passage of electromagnetic radiation at the wavelength of interest.

The sensor comprising a capacitor comprising the defect controlled nanotube can detect temperature, and the sensor can be characterized in comprising a semi-metallic carbon nanotube of high aspect ratio, for example greater than 10; broken and stabilized carbon bonds; a density of defects adjusted to broaden the bandgap to several times, for example 5 times, that of thermal energy corresponding to the temperature of interest; a protection layer with high thermal conductivity to prevent exposure to ambient gases; and an opaque housing.

The sensor comprising a capacitor comprising the defect controlled nanotube can detect humidity, and the sensor can be characterized in comprising a carbon nanotube of high aspect ratio of, for example, greater than 10; broken and stabilized carbon bonds; high density of defects without compromising the integrity of the nanotube; opaque housing to prevent exposure to light, the housing being permeable to water molecules in the ambient atmosphere.

The sensor can comprise a transistor comprising the defect controlled nanotube on a upper surface of an insulating film, a drain electrode and a source electrode at the opposing ends of the nanotube, and a gate electrode on a lower surface of the insulating film, and when a voltage is applied between the source electrode and the drain electrode of the transistor, a conductivity between the source electrode and the drain electrode of the transistor is output as an electrical signal, the conductivity being affected by the physical and/or chemical quantity.

The sensor comprising a transistor comprising the defect controlled nanotube can comprise a detector formed by a semiconductor substrate or an insulating substrate and including a sensor structure integrally including a deformation portion deformable, when a physical quantity to be detected is applied to the sensor structure, due to the physical quantity, and a support portion for supporting the deformation portion, and the transistor can be provided on the deformation portion for detecting a deformation.

The sensor comprising a transistor comprising the defect controlled nanotube can detect light, and the sensor can be characterized in comprising a carbon nanotube of small diameter, for example less than 1 nm, and having low aspect ratio, for example, less than 10; broken and stabilized carbon bonds; density of defects adjusted to obtain a bandgap which corresponds to the energy of the photons at the wavelength of interest; a transparent protection layer to prevent exposure to ambient gases; and a transparent housing which allows passage of electromagnetic radiation at the wavelength of interest.

The sensor comprising a transistor comprising the defect controlled nanotube can detect temperature, and the sensor can be characterized in comprising a semimetallic type carbon nanotube of high aspect ratio, for example, greater than 10; broken and stabilized carbon bonds; density of defects adjusted to broaden the bandgap to several times, for example, 5 times, that of thermal energy corresponding to the temperature of interest; a protection layer with high thermal conductivity to prevent exposure to ambient gases; and an opaque housing.

The sensor comprising a transistor comprising the defect controlled nanotube can detect humidity, and the sensor can be characterized in comprising a carbon nanotube of high aspect ratio, for example, greater than 10; broken and stabilized carbon bonds; high density of defects without compromising the integrity of the nanotube; opaque housing to prevent exposure to light, and the housing being permeable to water molecules in the ambient atmosphere.

### BRIEF DESCRIPTION OF THE DRAWINGS

This object and features of the present invention will become apparent from the following description taken in conjunction with the preferred embodiments thereof with reference to the accompanying drawings in which:

FIG. 1 illustrates an example of a nanotube of 1 nm length without defect;

FIG. 2 illustrates an example of a nanotube of 1 nm length with a defect wherein one carbon-to-carbon bond is broken, such as by external manipulation such as UV radiation, X-rays, ion beam, electron beam, etc.;

FIG. 3 illustrates an example of a nanotube of 1 nm length with a defect wherein one carbon-to-carbon bond is broken and stabilized with hydrogen, such as by attaching to incomplete bonds by providing a H rich environment;

FIG. 4 illustrates an example of a nanotube of 1 nm length with a defect wherein one carbon has sp3 bonding (4 bonds), the rest of the carbons have sp2 bonding (3 bonds);

FIG. 5 illustrates an example of a nanotube of 1 nm length with a defect wherein one carbon atom of the 6 member ring is knocked off to form a 5 member ring;

FIGS. 6(a) and 6(b) illustrate amplification of internal strain by defects;

FIG. 7 illustrates an example of a mechanical sensor to detect strain;

FIG. 8 illustrates an example of a humidity sensor wherein water molecules interact with the nanotube;

FIG. 9 illustrates an example of a temperature sensor wherein atoms receive thermal energy and some electrons get excited to upper energy states;

FIG. 10 illustrates an example of a light (electromagnetic radiation) sensor wherein incident radiation excites some electrons to higher energy states;

FIG. 11 illustrates an example of a multi-sensor with multiple nanotubes;

FIG. 12 illustrates a basic diagram of a defect controlled sensor;

FIGS. 13(a), (b) and (c) illustrate examples of a nanotube as a resistive circuit element;

FIGS. 14(a), (b), (c), (d) and (e) illustrate examples of a nanotube as a capacitive circuit element;

FIGS. 15(a) and (b) illustrate graphs showing controlling bandgap of nanotubes with an external electric field;

FIGS. 16(a), (b), (c) and (d) illustrate examples of a nanotube as the channel of a MOSFET transistor; and

FIGS. 17(a), (b) and (c) illustrate examples of signal processing circuits including a nanotube as a resistor, a capacitor or a transistor, respectively.

### DETAILED DESCRIPTION OF THE INVENTION

Prior to discussing the specifics of the invention, the following definitions are provided to assist in understanding the present invention.

“Nanotube” is a tube formed of atoms in a fullerene structure, and is usually of a high aspect ratio having a length which is of a magnitude greater than its diameter.

“Backbone” of the nanotube is utilized to define the structure formed by an array of atoms that are bonded together to form a nanotube.

“Backbone atom” is utilized to indicate the atoms that form the backbone of the nanotube. For example, the preferred nanotube will be formed of carbon atoms; however, nanotubes can be formed of other atoms such as atoms that can form sp2 type of bonding (3 bonds) such as boron nitride.

“Doping” of the nanotube includes the inclusion in the nanotube of atoms different from the backbone atoms. This is similar the inclusion of a dopant (or impurity) in the semiconductor industry to refer to atoms different from the host.

“Stabilizing atom” is defined as an atom that is incorporated into a bond of the backbone of the nanotube to bind with an open bond. For example, a hydrogen atom can be included on an open carbon bond to stabilize the carbon atom. These stabilizing atoms are often included in the backbone of atoms that form the end atoms of the nanotube, but can be included on any atom in the backbone. In other words, such stabilizing atoms are part of the backbone.

“No-defect nanotube” and “Low-defect nanotube” are nanotubes that have no or substantially no defects therein. As will be further expanded upon herein, no-defect and low-defect nanotubes may have incidental defects therein. Such incidental defects can be present in a low number and are not controlled as to type. Moreover, incidental defects contained in the nanotube are not in any controlled order.

“Defect controlled nanotube” is a nanotube that has a high number of defects and/or a high number of one type of defect to provide enhanced electrical characteristics when the nanotube is used as a sensor. For example, a no-defect or low-defect nanotube can be subjected to treatment, such as with electromagnetic radiation, to increase the density of defects in the nanotube and/or vary the type of defects in the nanotube with a corresponding change in electrical characteristics of the nanotube.

“Sensor” refers to a nanotube being used to measure a physical and/or chemical quantity, such as but not limited strain, temperature, light and humidity. The measurement can be based upon a change in any electrical characteristic and can rely upon, for example, and without limitation, a change in resistance, capacitance, polarization, etc.

“Gauge factor” is a functional change in the value of output to the input, and particularly an electrical component as a function of strain. For example, based upon the electrical component being a resistance, the gauge factor is a ratio of the relative change of resistance to strain ((δR/R)/L with R being resistance and L being strain).

The present invention is directed to nanotubes, preferably carbon nanotubes which are defect enhanced. In contrast to conventional nanotubes, the nanotubes according to the present invention have advantageous properties that permit their use in a wide variety of applications. The nanotubes according to the present invention have qualities that permit the nanotubes to be utilized in circuits and/or sensors while providing advantageous sensitivity in their use, and control in their application.

It is difficult to control the number of nanotubes in a bundle, and the properties of each nanotube. Approximately 70% of nanotubes have semiconductive properties (semiconductive nanotubes) and the remainder have conductive properties (metallic nanotubes). Still further, bond length or bond angle between backbone atoms, preferably carbon atoms, change with conditions, such as pressure, and such change influences electrical properties. Without wishing to be bound by theory, in the case of semiconductive nanotubes, variations of bandgap, such as caused by pressure on the nanotube, can comprise the basic mechanism of variations in electrical characteristics of nanotubes. Especially in semiconductive nanotubes, the number of electrons excited to the conduction band exponentially increases or decreases, and the resistance significantly changes. Accordingly, while semiconductive nanotubes grow in large numbers during the nanotube growth process, it is desirable to make as many nanotubes as possible, and preferably all nanotubes, semiconductive nanotubes. Moreover, as will be discussed below in further detail, post treatment of nanotubes to add defects to vary their density and/or type can change nanotubes from metallic (conductive) to semiconductive nanotubes. Thus, metallic nanotubes with nearly zero bandgap can be converted to semiconductive nanotubes with larger bandgap by introduction of defects. Moreover, while nanotubes according to the present invention can be metallic or semiconductive, semiconductive nanotubes are preferred.

Defect controlled nanotubes according to the present invention comprise nanotubes wherein the bonds between the atoms comprising the backbone, preferably carbon backbone, of the nanotubes are treated to induce defects in bonds associated with the atoms that are at a higher density of defects and/or include higher densities of desired defects than which may be incidentally included in nanotubes. Preferably, the defect controlled nanotubes according to the present invention comprise nanotubes that are treated after their formation to increase defects present therein. However, the invention is not limited to such production of defect controlled nanotubes, and defect controlled nanotubes can be directly formed in a nanotube production process. Thus, a defect controlled nanotube is preferably one which is subjected to a processing operation to include defects of a well defined characteristic energy and density in the nanotube. The treatment of a nanotube with, such as, but not limited to, radiation, will hereinafter also be referred to as post treatment, with the nanotube being referred to as being post treated. A nanotube that is not post treated will be referred to as a non-post treated nanotube.

Still further, the defect controlled nanotubes according to the present invention include defects therein, preferably defects being introduced therein by post treatment, to serve a function, such as increasing sensitivity of the nanotube as a sensor. For example, in a strain sensor utilizing a change of resistance based upon deformation of the nanotube, the nanotube will be capable of providing measurable detection even at low strain levels. In other words, by including controlled density and/or type of defects in the nanotube, the nanotube will have unexpected beneficial properties. In contrast, incidental defects that may be included in nanotubes would be random in type and density.

The defects of the present invention comprise changes to the bonds forming the backbone of the nanotube, preferably a carbon nanotube, such as, but not limited to, the opening of bonds, the changing of number of bonds of the backbone atom, such as sp3 bonding (4 bonds) as compared to sp2 (3 bonds) and/or the forming of rings having greater or less than 6 atoms, such as five carbon atom rings.

The defects according to the present invention comprise defects that are associated with the bonds of the backbone atoms, and do not require any doping with atoms that are different from the background atom. Thus, the defects of the present invention do not include the necessity to include different atoms than the backbone atom or atoms, such as when a nanotube is formed of carbon for a carbon nanotube, and boron and nitrogen for a boron nitride nanotube. However, the nanotubes according to the present invention can include different atoms, and therefore can be doped in addition to being defect enhanced. In other words, nanotubes according to the present invention can be doped in addition to being defect enhanced. Preferably, the nanotubes of the present invention are only defect enhanced, and do not include additional atoms, except for atoms, such as hydrogen atoms, to stabilize the backbone atoms.

The nanotubes of the present invention are preferably produced and/or treated in such a manner as to provide sufficient density of defects and/or types of defects to be useful as sensors. By having a controlled inclusion of density of defects and/or type of defects in the nanotube, the present invention provides superior nanotubes showing advantageous properties, and that are particularly useful as sensors. The present invention provides for control and adjustability of nanotube sensors, and provides a nanotube sensor that is capable of providing detection with a sensitivity that is not presently obtainable with nanotubes.

Useful techniques for determining defect controlled nanotubes according to the present invention and the density and/or type of defects associated therewith is to utilize instrumentation for observing defects in the nanotubes, and preferably by directly observing the defects in the nanotubes. For example, a scanning probe microscope, such as Scanning Probe Microscope, Model CP-R available from Veeco, N.Y., or any instrument capable of observing the number and type of defects in the nanotube, can be used to count defects and determine the type of defect, such as open bond or a change in number of bonds.

According to the present invention, one manner of determining a defect controlled nanotube is to determine a density of defects along the length of the nanotube. In a defect controlled nanotube having a length of 1 μm or greater, there will be at least one section along the length of the nanotube that has a density of defects of at least 2 defects per 100 nm, preferably at least 2 defects per 50 nm, more preferably at least 2 defects per 10 nm, and even more preferably at least 2 defects per 1 nm.

Still further, preferably the nanotube having a length of 1 μm or greater, has at least 10 defects along at least one 1 μm length of the nanotube. Accordingly, along at least one measured length of 1 μm along the length of the nanotube, there will be at least 10 defects, at least 20 defects, at least 30 defects, at least 50 defects, at least 75 defects, at least 100 defects, at least 200 defects, at least 500 defects, or at least 1000 defects in the measured 1 μm length along the nanotube. For example, an observation of any 1 μm section along the length of the nanotube will reveal at least 10 defects, and preferably more than 20 defects.

For a nanotube having a length of less than 1 μm, any section along the length of the nanotube comprising 30% of an entire length of the nanotube is measured. Such 30% section, hereinafter also referred to a “30% section”, when normalized to a size of 1 μm, will include at least 10 defects, at least 20 defects, at least 30 defects, at least 50 defects, at least 75 defects, at least 100 defects, at least 200 defects, at least 500 defects, or at least 1000 defects in the measured 30% section. For example, an observation of any 30% section along the length of the nanotube will reveal at least 10 defects, and preferably more than 20 defects when normalized to a size of 1 μm.

As an example of normalization, the following normalization to a 1 μm section is provided. If the nanotube is 500 nm, than a 30% section of the nanotube comprises a section having a length of 150 nm. To normalize this 150 nm section to 1 μm, requires multiplication by a factor of 6.67 which is equal to 1000 nm/150 nm. Thus, if the 150 nm section has 10 defects, it normalized number of defects will be 10×6.67-66.7 defects.

While it is noted that only at least one section need have the density of defects noted above, it is preferable that substantially all, and even more preferably each measured section, of the nanotube have the density of defects. With regard to substantially all sections, it is noted that the attachment of contacts to the nanotube may affect the density of defects in sections adjacent thereto. Accordingly, such sections may not have the indicated density of defects.

Another manner of determining a defect controlled nanotube according to the present invention is to determine one type of defect (as compared to other types of defects) along at least one 1 μm section of the nanotube for a nanotube of a length of 1 μm or greater. In at least one 1 μm section of the nanotube, one type of defect will occur at a number of at least 5 times an average number of other defects in the nanotube. For example, the number of open bond defects is at least 5 times an average number of sp2 defects and 5 membered ring defects. Preferably, an defect controlled nanotube according to the present invention will have one type of defect that is at least 10 times, at least 20 times, at least 30 times, at least 50 times, at least 75 times, at least 100 times, at least 200 times, at least 500 times, or at least 1000 times the average number of other defects in at least one 1 μm length along the length of the nanotube. For example, an observation of at least one 1 μm section of the nanotube should reveal the one type of defect being present at at least 5 times the average number of other types of defects in the same section.

Still further, for a nanotube having a length of less than 1 μm, instead of measuring at least one 1 μm section for a type of defect (as compared to other types of defects), a 30% section of the nanotube will be used. Along at least one 30% section of the nanotube, one type of defect will occur at a number of at least 5 times an average number of other defects in the nanotube. For example, the number of open bond defects is at least 5 times the average number of sp2 defects and 5 membered ring defects. Preferably, a defect controlled nanotube according to the present invention will have one type of defect that is at least 10 times, at least 20 times, at least 30 times, at least 50 times, at least 75 times, at least 100 times, at least 200 times, at least 500 times, or at least 1000 times the average number of other defects in at least one 30% section along the length of the nanotube. For example, an observation of at least one 30% section of the nanotube should reveal the one type of defect being present at at least 5 times the average number of other types of defects in the same section.

While it is noted that only at least one section need have the number of type of defects noted above, it is preferable that substantially all, and even more preferably each measured section, of the nanotube have the stated types of defects. With regard to substantially all sections, it is noted that the attachment of contacts to the nanotube may affect the types of defects in sections adjacent thereto. Accordingly, such sections may not have the indicated types of defects.

Preferably, the nanotubes according to the present invention include a combination of defects. Thus, for example the nanotubes according to the present invention preferably have at least 2 defects per 100 nm and/or at least 10 defects along any 1 μm section of the nanotube for nanotubes of 1 μm or greater, or at least 10 defects, when normalized to a 1 μm section, in a 30% section for nanotubes less than 1 μm, and along any measured 1 μm section along the length of the nanotube, one type of defect will occur at a number of at least 5 times total number of other defects in the nanotube for nanotubes 1 μm or greater, or along any measured 30% section along the length of the nanotube, one type of defect will occur at a number of at least 5 times total number of other defects in the nanotube for nanotubes of less than 1 μm.

Moreover, preferably the density and/or types of defects will be uniformly distributed at least along a central ⅓ of the length of the nanotube, and most preferably along an entire or substantially an entire length of the nanotube. For example, the placement of contacts on ends portions of the nanotube may affect the atoms at the ends of the nanotube, and therefore affect uniformity at ends of the nanotube.

Resistance of carbon nanotubes can be used as a macroscopic measurement by which one can monitor the defect creation process and roughly quantify the density of defects for carbon nanotubes. However, an accurate measurement of a defect controlled nanotube resides in the above-noted technique of using an instrument, such as a scanning probe microscope, to observe the surface of the nanotube, such as by scanning, with a fine probe to observe the presence, type and/or density of defects at the atomic level.

A carbon nanotube having no defects would be expected to have a resistance of about 6 to 7 kilo-ohms. According to a review article by Dai, Surface Science, p.218, 2002, the disclosure of which is incorporated by reference in its entirety, theoretical resistance of a metallic carbon nanotube is 6.45 kilo-ohms. However, the article notes that experimental values of similar nanotubes range from 10 s to 100 s of kilo-ohms, and provides 12 kilo-ohm as an example of an experimentally achieved low value.

An individual metallic carbon nanotube or a metallic carbon nanotube in a bundle according to the present invention preferably has a resistance of greater than 20 kilo-ohms, more preferably at least about 50 kilo-ohms, even more preferably about 100 kilo-ohms, and even more preferably more than 500 kilo-ohms. The preferred resistance will depend upon the specific sensor and the characteristic and/or substance to the determined. Furthermore, resistance values of nanotubes of other than carbon atoms may be different depending on electrical characteristics. For example boron-nitride nanotubes are all semiconductive, so their room temperature resistance might be very large, like in the order of mega-ohms.

It is noted that resistance in a nanotube could be due to defects in the nanotube, or it could be due to contact resistance. It is difficult to differentiate between the two unless one investigates at the atomic level. In practice carbon nanotubes are grown in bundles. There is about 30% chance of getting metallic nanotubes in the bundle. That 30% dominate the combined (parallel) resistance of the nanotube bundle. Therefore it is possible to obtain a total resistance of several kilo-ohms for a bundle.

Expanding upon the above, investigation of pre-existing defects in a statistically large number of nanotube samples, would show that defects, if any defects are contained in the nanotube, would be random in type and/or density. On the other hand, when defects are engineered in nanotubes according to the present invention, such as by post treatment, the defects are includes in the nanotube at a controlled density and/or a certain type of defect is generated in the nanotube, e.g., broken carbon-carbon bonds. For example, and without limitation, a preferred nanotube according to the present invention includes at least one 1 broken bond per 100 nm length of the nanotube, more preferably at least one 1 broken bond per 10 nm length of the nanotube, and even more preferable at least one broken bond per 1 nm length of the nanotube. The defect would have a characteristic energy, for example about 5 eV for the broken carbon-carbon bond, corresponding to about 250 nm UV light which is an example of a technique for post processing the nanotube. Moreover, as discussed above, defect controlled nanotubes are clearly distinguishable as to density and/or type of defects when examined at the atomic level.

As noted above, no-defect carbon nanotubes have a resistance of about 6 to 7 kilo-ohms, while low-defect carbon nanotubes have defects of a quantity and type to have a resistance of about 10 kilo-ohms. Without wishing to be bound by theory, as the number of defects increase the resistance increases. Moreover, different types of defects can provide different effects on resistance. Thus, it is once again noted that resistance changes of the nanotube can be measured when post treating the nanotube to ascertain increased resistance as well as to obtained desired resistance where appropriate.

Resistance according to the present invention is determined by applying a small DC voltage, e.g., less than 1 volt, to the contacts of a nanotube and measuring the current flowing through with a current measuring instrument.

Nanotubes according to the present invention can also be determined by evaluating properties of the nanotubes as a sensor. For example, sensor nanotubes according to the present invention can have increased sensitivity. In this regard, it is noted that an exemplary commercially available silicon piezo resistor operating at a strain of about 0.01% has a gauge factor of about 100 (1% change of resistance at the given strain). As discussed above, U.S. application Ser. No. 10/446,789, filed May 29, 2003 discloses strain gauges including carbon nanotubes in strain gauges in order to achieve higher sensitivity. While carbon nanotubes can have gauge factors reaching to 1000 at strains of several percent, carbon nanotubes do not exhibit a measurable change of resistance at strains of 0.01%. In order to enhance the sensitivity of nanotubes to small strains, the present invention is directed to defect controlled nanotubes which can also be referred to as enhanced defect nanotubes. For example, defect controlled nanotubes according to the present invention can exhibit significant resistance change of several percent at low strains of about 0.01%. Thus, the present invention increases sensitivity and broadens the operating range of sensors, such as nanotubes used as strain gauges, by incorporating defects in a controlled manner.

A nanotube according to the present invention provides a measurable response when subjected to a strain of 0.01%. In this regard, with current nanotubes and the sensitivity of current instruments and the characteristics, e.g., electrical properties, of the nanotube are not of such a nature to provide a signal indicative of the strain. Preferably, the nanotube has a gauge factor of at least 100, more preferably at least 200, even more preferably at least 500, and even more preferably at least 1000 when subjected to a strain of 0.01%.

Still another manner of detecting a nanotube according to the present invention is to compare a nanotube with a post treated nanotube. A post treated nanotube according to the present invention will have an increased sensitivity as a sensor when compared to the nanotube before post treatment. Thus, one method of determining a nanotube according to the present invention is to take a nanotube produced by any process, and subject that nanotube to post treatment to change the density and/or type of defect in the nanotube. The resulting post treated nanotube will have an increased sensitivity as a sensor comprising the post treated nanotube as compared to the non-post treated nanotube with all other conditions being the same. For example, the nanotube according to the present invention will have an increased gauge factor as compared to the non-post treated nanotube of at least 100, more preferably at least 200, even more preferably at least 500, and even more preferably at least 1000 when subjected to a strain of 0.01%.

Further expanding upon the above and as previously noted, defect controlled nanotubes according to the present invention comprise nanotubes wherein the bonds between the atoms comprising the backbone, preferably carbon backbone, of the nanotube are treated to induce defects in the bonds which are above that which may be incidentally included in nanotubes. In other words, the present invention provides for enhanced nanotubes by enabling adjustment and control of the properties of nanotubes which render the nanotube particularly useful as sensors. While defect controlled nanotubes can be prepared by other techniques, such as by directly producing a defect controlled nanotube, it is preferred to treat an already produced nanotube in such a manner to obtain a controlled increase in the number and/or type of defects. Therefore, a defect controlled nanotube is a nanotube which is subjected to a processing operation to include defects of a well defined characteristic energy and density per nanotube. Furthermore, defects are introduced to serve a purpose like increasing the variation of resistivity as a function of strain. Pre-existing defects in a nanotube would be random in type and density. Even when a desirable type of defect incidentally exists, its density might not be adequate for use in a sensor.

The present invention introduces defects into nanotubes preferably to enhance the sensing characteristics. The invention will be further defined with respect to the drawings.

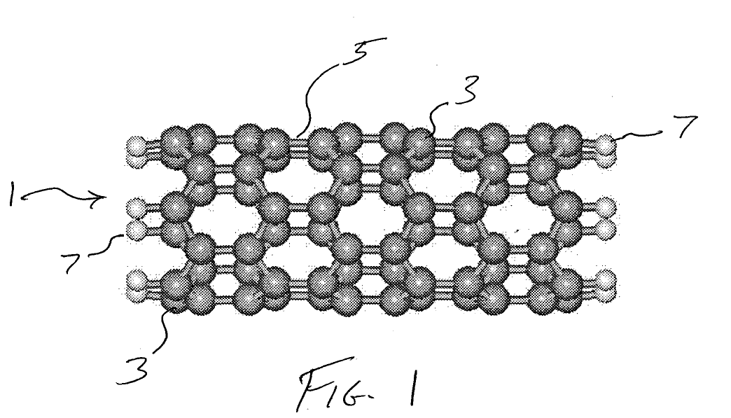

An ideal nanotube 1 is constructed of a well defined arrangement of atoms, such as illustrated in FIG. 1 wherein carbon atoms, depicted as atoms 3, are bonded together in six-membered rings generally depicted by 5 along the backbone of nanotube 1. At the ends of the backbone, hydrogen atoms 7 are included on the end carbon atoms.

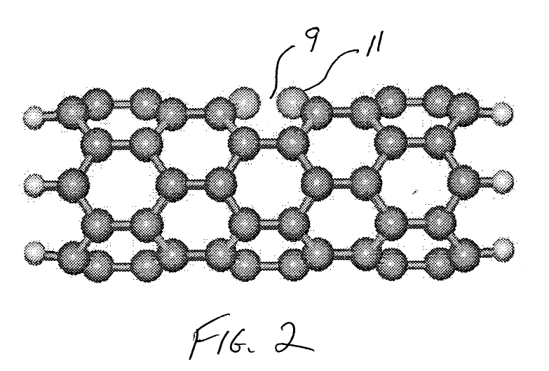

A simple example of a defect is illustrated in FIG. 2 wherein a carbon-carbon bond is broken. The broken bond 9 illustrated in FIG. 2 is unstabilized, and therefore includes unstabilized carbon atoms 11. The number of broken bonds can be varied depending upon the extent of sensitivity desired in the nanotube. For example, if the nanotube illustrated in FIG. 2 is utilized as a pressure sensor by measuring strain on the nanotubes, an increase in broken bonds should yield an increase in the sensitivity of the sensor.

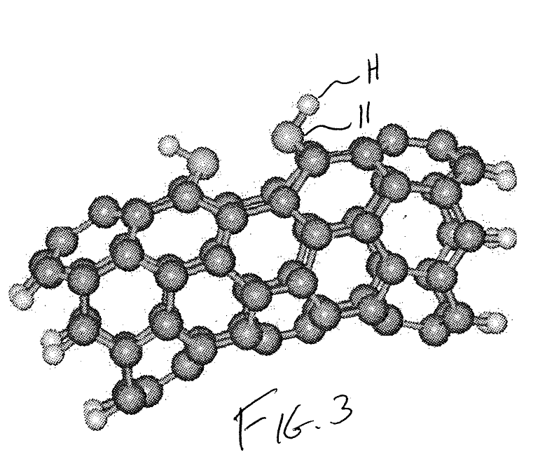

If left dangling, broken bonds might heal themselves such that the bonds reform. Moreover, the unstabilized atoms 11 may form bonds with an undesirable atom, such as an oxygen atom, in the vicinity of the nanotube. Therefore, depending upon on the application, it may be beneficial to stabilize the defect by bonding the unstabilized atom, preferably carbon atom 11, with a neutral atom, such as a hydrogen atom H illustrated in FIG. 3.

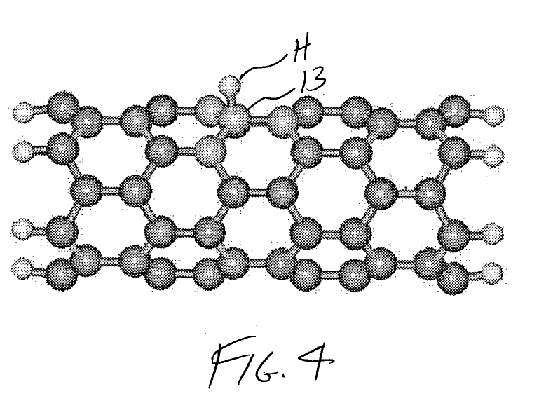

FIG. 4 illustrates another type of defect wherein one of the carbon atoms 13 of a carbon nanotube is converted from sp2 bonding (3 bonds) to sp3 bonding (4 bonds).

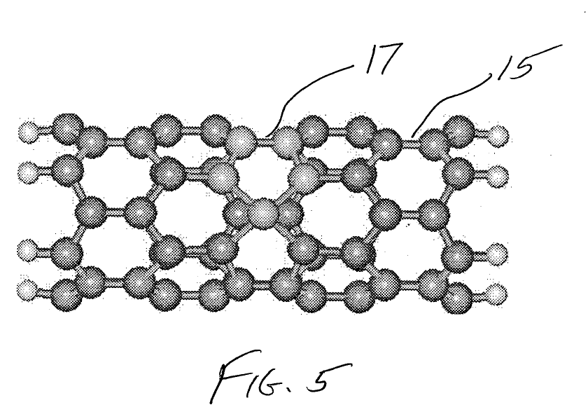

Still further, FIG. 5 illustrates another type of defect wherein 6 member rings 15 of the backbone are converted to 5 membered rings 17.

As noted above, nanotubes may contain defects accidentally produced during the growth process. These random defects are not of a sufficient density and/or type to produce the benefits as those engineered into the nanotube in a controlled manner by the present invention. In accordance with the present invention, defects are included in the nanotubes in a manner to provide sufficient defects to provide nanotubes having desired sensitivity and/or electrical characteristics for sensing purposes.

As will be further discussed below, defects can be included in nanotubes by any suitable technique, such as, for example, but not limited to radiating one or more nanotubes with electromagnetic radiation. Thus, electromagnetic radiation having desired energy levels can be utilized to form the level and type of defects in the nanotubes.

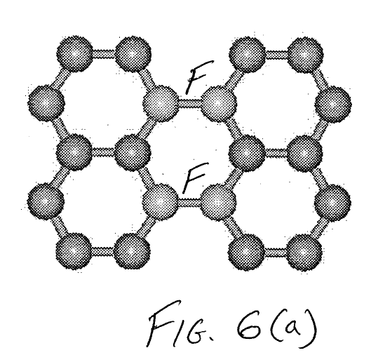

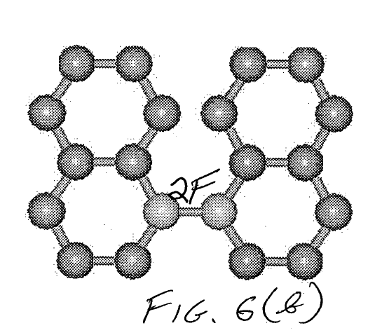

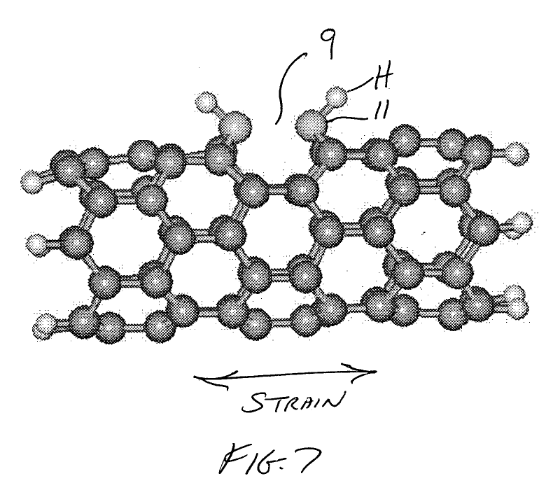

An example of benefits associated with defects according to the present invention can be seen with reference to a mechanical sensor which detects deformation. In FIG. 6a, a no-defect nanotube is illustrated having two bonds each depicted as being strained horizontally as a result of which the central two bonds are subjected to a force F. FIG. 6b illustrates a nanotube having one of these bonds intentionally broken or no present (a defect). In such an instance, the remaining bond would experience twice the force (depicted as 2F) when strained in the same way. Hence, internal strain in the enhanced defect nanotube illustrated in FIG. 6b would be amplified as a result of the defect. Likewise, forces acting on the bonds around the defect (open stabilized bond) of the nanotube shown in FIG. 7 would be amplified when it is strained.

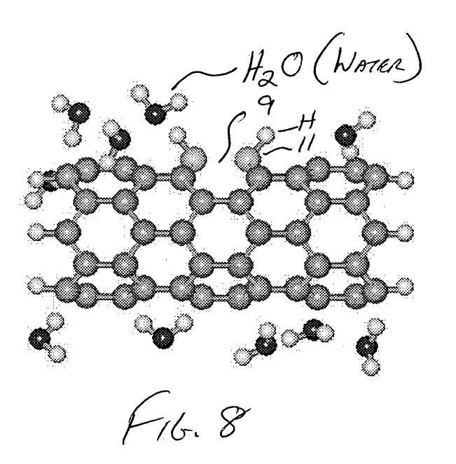

A second example of defect enhanced sensing is the humidity sensor illustrated in FIG. 8. Water molecules which are polar molecules induce changes in the nanotube charge (electron) distribution when they approach the nanotube. A defect in the nanotube, such as the open stabilized bond illustrated in FIG. 8, changes uniform charge distribution to a non-uniform one. Polar water molecules are more likely to interact with the non-uniform charge distribution due to its polarization rather with a uniform charge distribution. Thus, polar molecules, such as, but not limited to water, can be detected with defect controlled nanotubes according to the present invention.

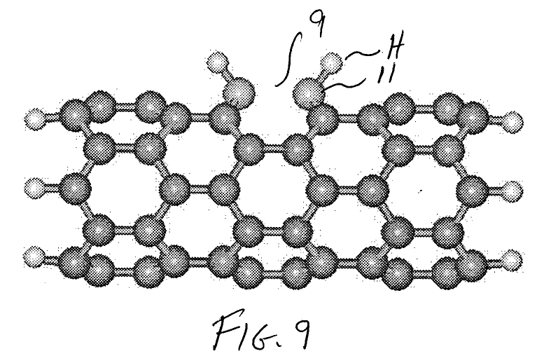

A third example of defect enhancement is the temperature sensor illustrated in FIG. 9. Nanotubes exhibit semi-metallic characteristics depending upon the atomic structure which means bandgap is small as compared to room temperature energy. By introducing defects, the bandgap can be increased to a level at which electrons jumping the bandgap with thermal energy modulate the electrical properties substantially. Hence, sensitivity of the nanotube to temperature variations is increased.

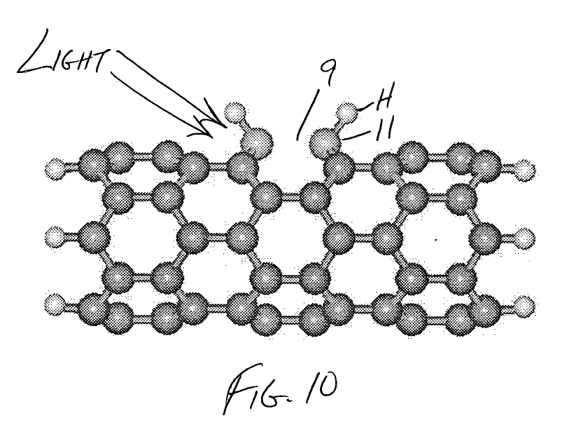

A fourth example of defect enhancement is the light sensor illustrated in FIG. 10. As mentioned above, bandgap of a nanotube can be adjusted by introducing defects. The bandgap determines the energy of absorption of electromagnetic radiation incident on the nanotube. For example, by controlled introduction of defects, the bandgap can be adjusted to absorb radiation of visible wavelengths to serve as a light sensor.

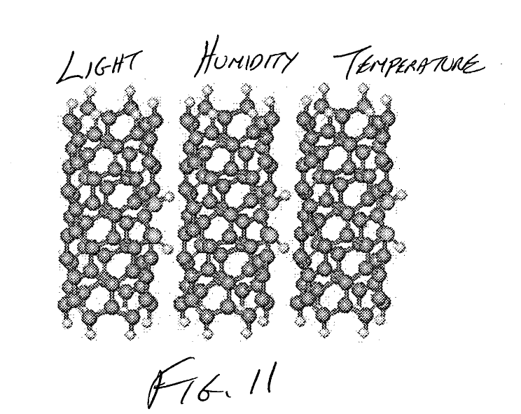

A number of these sensors can be combined to serve as a multi-sensor capable of detecting several quantities in parallel, such as, but not limited to, light, temperature and humidity, as in FIG. 11. Of course, design precautions should be taken such that each sensor is sensitive to only one target. For example, light sensors can be encapsulated in a transparent container or coating to be subject to the light, but not to humidity. Moreover, packaging can be structured to only expose the light sensor to ambient light.

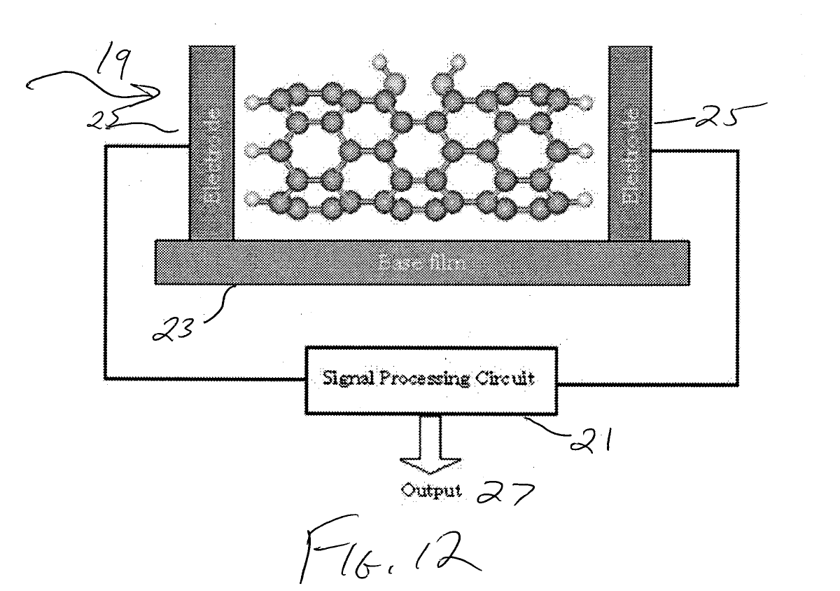

Typically, a nanotube sensor 19 as illustrated in FIG. 12 would be used in conjunction with a signal processing circuit 21 which provides electrical power and processes the signal from the sensor to produce an output in proportion to the quantity being detected. For example, the nanotube can be located on a base film 23, such as formed of silicon dioxide, and can include electrodes 25 at each end of the nanotube. The signal processing circuit 21 can provide an output signal 27 representative of the quantity being detected, such as but not limited to strain, pressure, humidity, temperature and light. Examples of sensors are disclosed in U.S. patent application Ser. No. 10/446,789, filed May 29, 2003, and Japanese Patent Laid-Open Publication No. 11-241903, whose disclosures are incorporated by reference herein in their entireties.

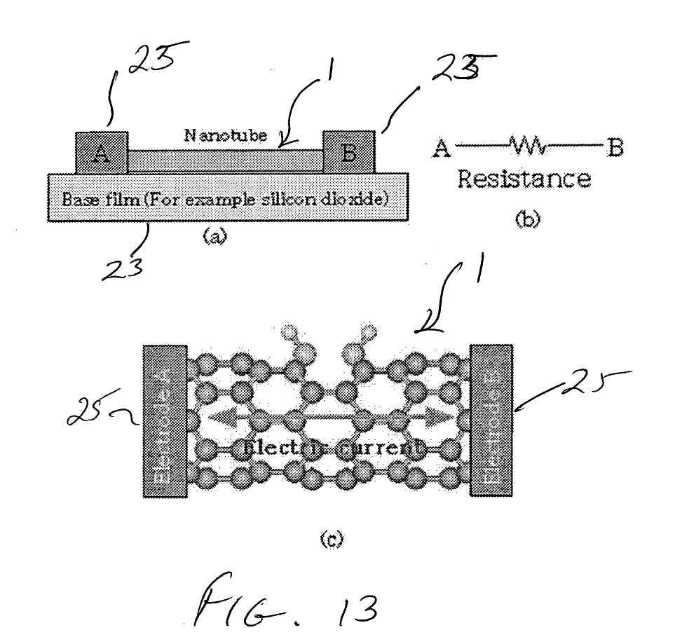

The nanotube 1 can be incorporated into the circuit in a number of different ways. For example, as illustrated in FIG. 13(a), (b) and (c), electrodes 25 can be attached to the nanotube to apply a voltage and to drive a current therehrough. In this case, the nanotube 1 is utilized as a resistor (FIG. 13(b)) in the circuit and the variation of its resistance as a function of the quantity being sensed can be processed. However, making good electrical contacts wherein the electrodes contact the nanotube, as illustrated in FIG. 13(c), is a problem. Moreover, oftentimes contacts add unwanted resistance to the device.

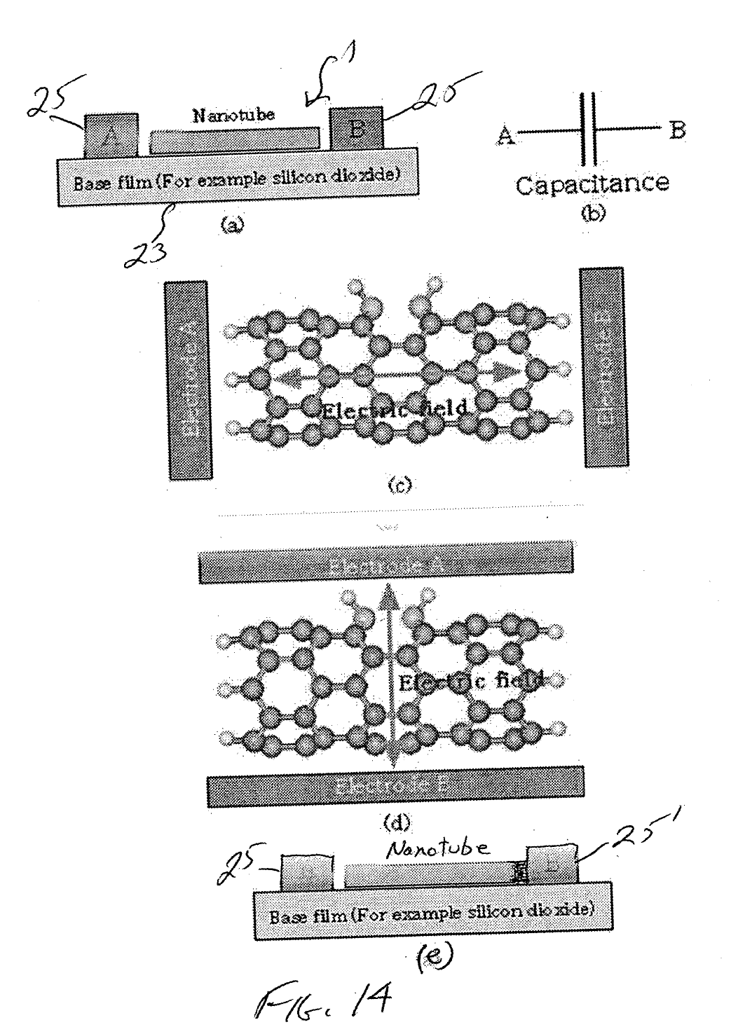

One manner of solving the contact resistance problem is to place the electrodes so as to apply an electric field (rather than pass a current) as illustrated in FIGS. 14(a)-(e). As illustrated in FIGS. 14(a)-(d), the electrodes 25 can be spaced from the nanotube 1 which is positioned on a base film 23, for example, but not limited to silicon dioxide. In other words, the electrodes 25 do not contact the nanotube. In this case, the nanotube 1 comprises a capacitor, such as illustrated in FIG. 14(b), and can be incorporated into a circuit as a capacitor. In such an instance, variation of polarizability of the nanotube as a function of the quantity being sensed is processed in the circuit. Thus, capacitance, e.g., polarizability, of the nanotube changes as a function of the quantity being detected, including but not limited to strain, pressure, temperature, light and humidity. In this embodiment, the sensor, which includes the nanotube and its spaced electrodes are set up in an electric field to polarize the nanotube.

The spacing of the electrodes from the nanotube can be varied depending upon the structure and characteristics of the nanotube, the applied electric field and the degree of sensitivity required. For example, the electrodes can be spaced from the nanotube so that the electrodes are as close as practically possible to the nanotube to increase the electric field. For example, and without limitation the electrode can be spaced preferably up to 10 micrometers from the nanotube, such as 2 to 10 micrometers from the nanotube, or 2 to 4 micrometers from the nanotube. However, most preferably the contact is spaced less than 1 micrometer from the nanotube. Moreover, one or more electrodes can be spaced from the nanotube, or only one electrode can be spaced from the nanotube. Thus, as illustrated in FIG. 14(e), one electrode 25 can be spaced from the nanotube, and the other electrode 25′ can be in contact with the nanotube.

The external electric field can be applied parallel to the nanotube as illustrated in FIG. 14(c), or perpendicular to the axis of the nanotube, as illustrated in FIG. 14(d), depending upon the circumstances. For example, in one circumstance the polarizability along the diameter direction varies more than that along the longitudinal direction as a function of the quantity being sensed. Another case is that a capacitor with more desirable properties, such as higher capacitance, is obtained by putting the electrodes along the length of the nanotube. Still further, the external electric field can be applied at varying angles to the nanotubes. Without wishing to be bound by theory, when the electric field is applied, the distribution of electrons changes and a dipole moment is induced.

Expanding upon the above, it is noted that current pressure sensors use piezo phenomenon of silicon, and utilize the sensor as a resistance element measured in Wheatstone bridge configuration. Carbon nanotube sensors can also be utilized as resistance elements. However, minimization of the resistance of contacts attached to the nanotube is a problem. Dimensions of nanotube are small, so contact area with the electrode is also small. Moreover, when nanotubes are bundled together, it is difficult to make a definite contact to each nanotube. Still further, adhesion of aluminum (which is a commonly used contact metal), with nanotubes is bad, so special metals like titanium or tungsten need to be used. If the contact resistance cannot be made small as compared to the nanotube resistance, the contact resistance will have an adverse effect on sensitivity of the sensor. e.g., gauge factor. Therefore, the present invention preferably utilizes the nanotube as a capacitor element in order to solve this problem. There is no need to make contact to the nanotube, so that aluminum can be used as the metal. Even if a nanotube bundle is used, the electric field can be applied to all the nanotubes. As noted above, it is possible to apply the electric field in any direction, such as perpendicular to the nanotube, or parallel to the longitudinal axis of the nanotube as well as directions therebetween.

If the nanotube capacitor is utilized as an element of a resonance circuit, resonance frequency can be measured to identify the variation of capacitance, e.g., pressure, accurately.

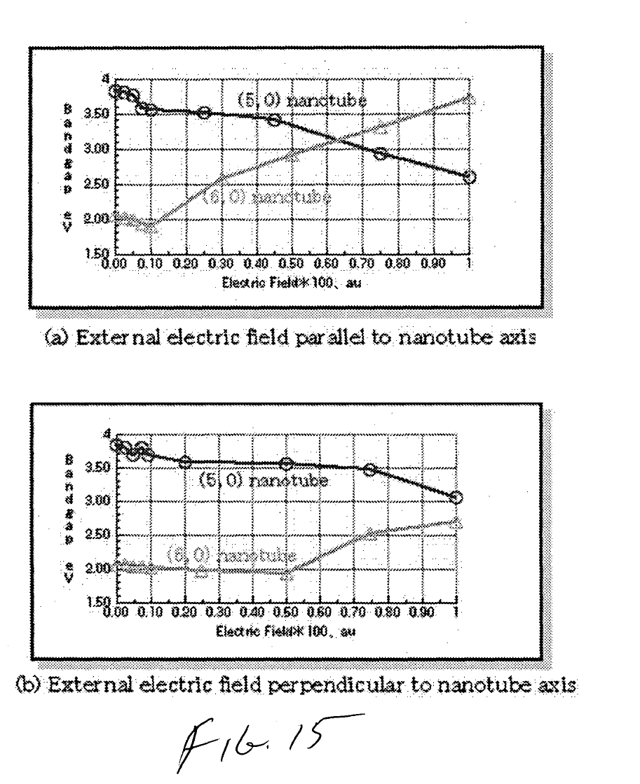

As illustrated in FIG. 15(a) for application of an external electric field parallel to the longitudinal axis of the nanotube and in FIG. 15(b) for application of an external electric field perpendicular to the longitudinal axis of the nanotube, an external electric field has the additional benefit of modifying allowed energy levels of the nanotube. For example, bandgap of the nanotube can be controlled using an external electric field as can be seen from the graphs illustrated in FIGS. 15(a) and (b).

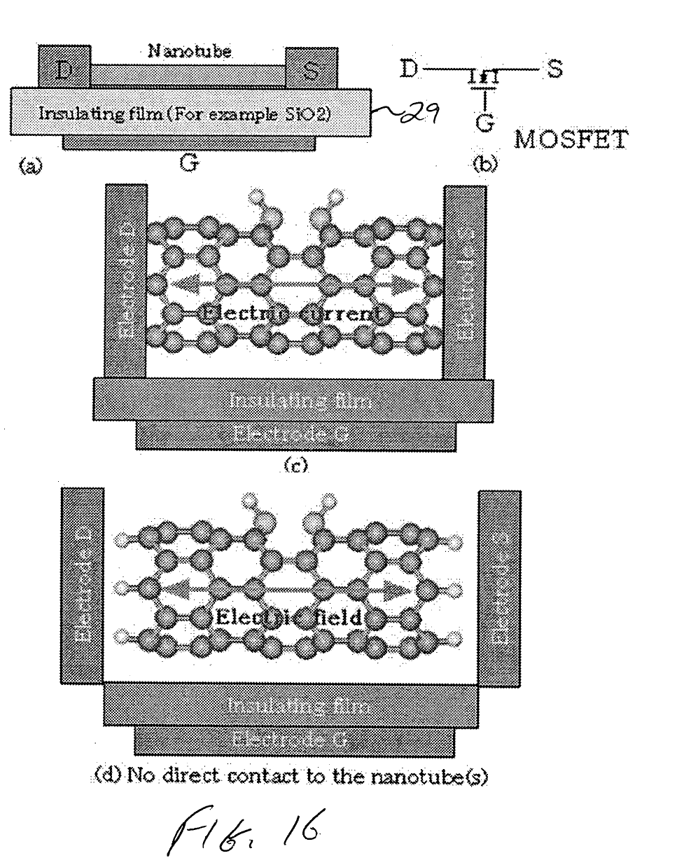

As discussed above, nanotubes can have semiconducting properties depending on the structure. Originally metallic tubes with nearly zero bandgap can be converted to semiconductive tubes with larger bandgap by introducing defects. A semiconductive nanotube can be used as the channel of a MOSFET transistor as illustrated in FIGS. 16(a)-(d). For example, as illustrated in FIG. 16(a), the nanotube can be positioned on an insulating film 29, of, for example, silicon dioxide, gate electrode (G) can be positioned on a side of the insulating film 29 opposite the side on which the nanotube is located, and the drain electrode (D) and source electrode (S) are located at opposite ends of the nanotube. The gate electrode can be insulated from the nanotubes in other manners then being positioned on the opposite side of the insulating film. Conductivity of the nanotube (channel) is modulated by a voltage applied to the gate (G) electrode. Such an arrangement provides the opportunity to control sensor characteristics by means of the gate voltage. Moreover, resistivity of the nanotube can also be controlled by the gate voltage. For example, resistivity of the nanotube can change as a function of the quantity being detected, such as but not limited to strain, pressure, temperature and humidity.

Traditionally, drain (D) and source (S) electrodes contact the channel to allow current flow as in FIG. 16(c). In view of the contact problem discussed with respect to FIG. 14, the electrodes can be placed without direct contact to the nanotube as illustrated in FIG. 16(d). In that case, the transistor can be operated as a capacitor controlled by gate voltage.

As discussed above with respect to FIG. 14, the spacing of the electrodes from the nanotube can be varied depending upon the structure and characteristics of the nanotube, the applied electric field and the degree of sensitivity required. For example, the electrodes can be spaced from the nanotube so that the electrodes are as close as practically possible to the nanotube to increase the electric field. For example, and without limitation the electrode can be spaced preferably up to 10 micrometers from the nanotube, such as 2 to 10 micrometers from the nanotube, or 2 to 4 micrometers from the nanotube. However, most preferably the contact is spaced less than 1 micrometer from the nanotube. Moreover, one or more electrodes can be spaced from the nanotube, or only one electrode can be spaced from the nanotube. Thus, one electrode can be spaced from the nanotube, and the other electrode can be in contact with the nanotube.

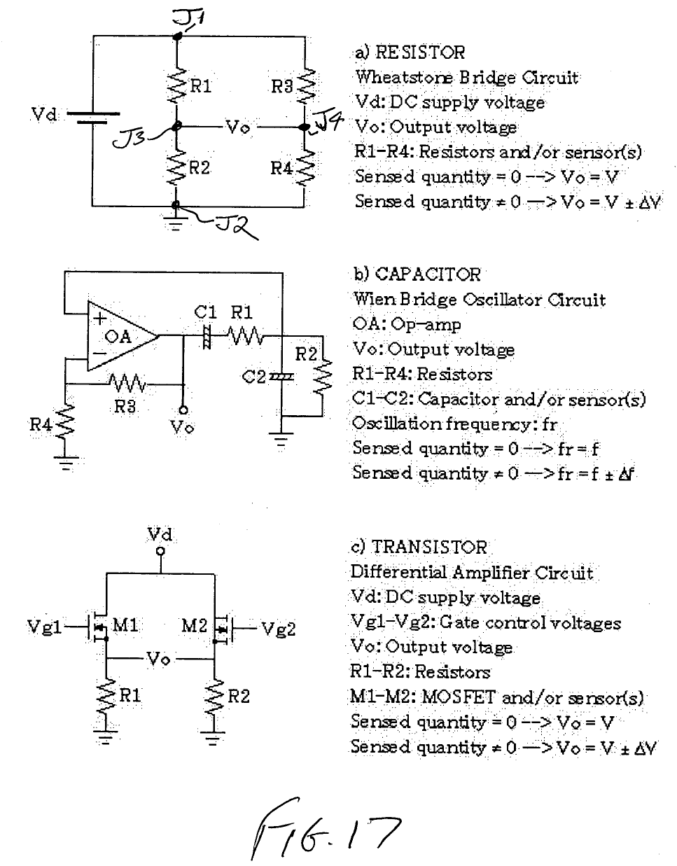

Examples of circuits in which the nanotube according to the present invention are illustrated in FIGS. 17(a)-(c). However, these circuits are merely being provided to provide guidance as to the use of defect controlled nanotubes being utilized as resistors, capacitors and transistors, and are not intended in any manner to limit the invention to such exemplary circuits.

FIG. 17(a) illustrates an example of at least one nanotube that is utilized in a Wheatstone Bridge circuit. Due to their outstanding sensitivity, Wheatstone Bridge circuits are very advantageous for the measurement of resistance, inductance, and capacitance, and are widely used for strain measurements. In the illustrated example, four resistors R1, R2, R3 and R4 are arranged in a diamond configuration (e.g., they are arranged having four legs). A defect controlled nanotube having resistive properties is used for at least one of the four resistors R1 to R4 as a strain gauge. For example, resistor R1 (e.g., leg 1) may comprise the defect controlled nanotube sensor, while the remaining resistors (e.g., legs 2, 3 and 4) comprise completion resistors with a resistance equal to that of the defect controlled nanotube sensor.

An input DC supply voltage (excitation voltage) Vd is applied between junction J1 of resistors R1 and R3 and junction J2 of resistors R2 and R4, and an output voltage Vo is measured between junctions J3 and J4. When the output voltage Vo is zero, the bridge is said to be balanced. As the resistance of one of the legs changes, due to, for example, a change in strain applied to the defect controlled nanotube sensor (e.g., resistor) R1, the previously balanced bridge becomes unbalanced. This unbalance causes the output voltage VO to become a value other than zero. The output voltage Vo produced by the change in resistance of the defect controlled nanotube R1, as it is being subjected to the strain, is measurable (by, for example, a microprocessor, not shown) to obtain the engineering units of strain.

While the Wheatstone Bridge circuit of 17(a), is described with respect to the use of a single defect controlled nanotube sensor, it is understood that more than one resistor R1 to R4 may comprise a defect controlled nanotube resistance device (sensor), without departing from the spirit and/or scope of the present invention. Furthermore, while the defect controlled nanotube sensor is described as a resistance device (e.g., strain gauge) used in a Wheatstone Bridge circuit, it is understood that defect controlled nanotubes exhibiting resistive properties are not limited to being used in Wheatstone Bridge circuits, but may be used in any electrical circuit that requires a resistor therein.

FIG. 17(b) illustrates an alternative use of a defect controlled nanotube. In the example, of FIG. 17(b), the defect controlled nanotube exhibits capacitance properties, and is employed in an oscillator, specifically a Wien Bridge Oscillator circuit, to produce specific, periodic waveforms. A Wien Bridge Oscillator comprises an operational amplifier (op amp) OA, such as, but not limited to, for example, Texas Instrument's TLV2471, resistive devices (e.g., resistors) R1, R2, R3 and R4, and capacitive devices (e.g., capacitors) C1 and C2.

In the following discussion, the Wien Bridge Oscillator will be described with respect to the use of a single defect controlled nanotube having capacitance properties, that is utilized as a capacitance device. However, it is understood that more than one defect controlled nanotube having capacitive properties may be employed, and that the Wien Bridge Oscillator may further employ at least one defect controlled nanotube having resistive properties in addition to, or instead of, the at least one defect controlled nanotube having capacitive properties. Further, while the defect controlled nanotube sensor having capacitive properties is described as being utilized in a Wien Bridge Oscillator, it is understood that such a defect controlled nanotube may be employed in any electrical circuit requiring a capacitive device.

A first end (not labeled) of capacitive device C1 is connected to an output of the op amp OA. A first end (not labeled) of the resistive device R1 is connected to a second end (not labeled) of the capacitive device C1. A second end (not labeled) of the resistive device R1 is connected to a non-inverting input (+ input) of the op amp OA, and additionally connected to a first end of capacitive device C2 and a first end of resistive device R2. A second end of the capacitive device C2 and a second end of the resistive device R2 are electrically grounded.

The output of the op amp OA is further connected to a first end of the resistive device R3, while a second end of the resistive device R3 is connected to the inverting input (− input) of the op amp OA. One end of the resistive device R4 is also connected to the inverting input of the op amp OA, while its second end is electrically grounded.

Output voltage Vo at the output of the op amp OA oscillates at a predetermined oscillation frequency fr. The oscillation frequency fr at the output of the op amp OA is equal to ½πR1C1. As indicated above, a defect controlled nanotube sensor is employed as the capacitive device C1. As a result, when the defect controlled nanotube sensor C1, having capacitive properties, is subjected to a strain, the value of the capacitive device C1 changes, which results in a change of frequency at the output of the op amp OA. That is, the capacitance of the defect controlled nanotube changes as a function of a quantity being sensed, resulting in the oscillation frequency fr changing. This frequency change is measurable by, for example, a microprocessor (not shown) to relate the variations in frequency to the sensed quantity.

FIG. 17(c) illustrates an example, in which the defect controlled nanotube is utilized as a transistor in a Differential Amplifier circuit. However, it is understood that the defect controlled nanotube may be used for both transistors in the Differential Amplifier circuit. Furthermore, defect controlled nanotubes having capacitive and/or resistive properties may additionally be used. Still further, it is understood that defect controlled nanotubes functioning as transistors may further be utilized in electrical circuits other than Differential Amplifier circuits.

A Differential Amplifier has two inputs, each input typically being out-of-phase with the one another. The Differential Amplifier circuit amplifies the difference between the two inputs. An advantage of such an arrangement is that noise applied to the two inputs is reduced, if not cancelled.

In the illustrated Differential Amplifier circuit, transistors M1 and M2 comprise metal oxide semiconductive field effect transistors, commonly referred to as MOSFETs. For purposes of simplicity, the following discussion is limited to MOSFET M1 being a defect controlled nanotube. However, as noted above, MOSFET M2, or MOSFET M1 and M2 may be defect controlled nanotubes.

In the discussed Differential Amplifier circuit, the first signal is inputted to gate Vg1 of n-channel MOSFET M1, while the second signal Vg2 is inputted to gate Vg2 of n-channel MOSFET M2. While FIG. 17(c) illustrates the defect controlled nanotube fabricated as an n-channel MOSFETs, it is understood that they may also be fabricated as p-channel MOSFETs without departing from the scope and/or spirit of the invention.

A DC supply voltage is supplied to the drain of each transistor M1 and M2. A first resistance device R1 is connected between the source of transistor M1 and ground. A second transistor R2 is connected between the source of transistor M2 and ground. The difference between the two signals Vg1 and Vg2 is amplified and outputted as an output signal Vo.

It is noted that the output signal Vo is dependent upon the internal drain-source resistance of each MOSFET M1 and M2. The internal drain-source connection of the MOSFET comprises the defect controlled nanotube. As the resistivity of the defect controlled nanotube changes as a function of the quantity being sensed, the out signal Vo changes.

It is noted that the resistivity of the defect controlled nanotube may be controlled by a gate voltage. Further, the defect controlled nanotube may be operated at low resistance or high resistance. Variations in nanotube resistance as a function of the sensing quantity can thus be different at different resistance values. Thus, the sensitivity of the sensor (defect controlled nanotube) can be adjusted via the gate voltage.

The nanotubes according to the present invention can be single-wall nanotubes or multi-wall nanotubes, with single-wall nanotubes being preferred. Without being wished to be bound by theory, when a nanotube is utilized as a sensor, a single wall nanotube comprises only one layer of atoms, and will therefore be expected to be more sensitive to external perturbations and to defects as well.

The nanotubes can have varying dimensions, and can depend upon the intended use of the nanotube as well as its backbone atom(s). For example, the nanotubes can have lengths of as small as 1 nanometer and as large as many micrometers, such as, and without limitation, lengths of, for example, 10 s of nanometers to several micrometers, with preferred nanotubes having a length of about 10 nanometers to 3 micrometers, more preferably about 100 nanometers to about 2 micrometers.

The diameter can also vary from about less than about 0.5 nm and up, such as, but without limitation, to about 50 nanometers or more, preferably less than about 2, and most preferably about 0.5 to 2 nm. Multiwall nanotubes will usually have larger diameters as compared to single wall nanotubes.

Preferred aspect ratios, i.e., length to diameter of the nanotubes, are greater than about 2, greater than about 10, greater than about 20, greater than about 50, and greater than about 100. Higher aspect nanotubes are desirable because end effects can be neglected. Moreover, higher aspect ratios provide more room to attach contacts. However, shorter lengths may be preferable in instances such as where length influences properties of interest, such as bandgap.

Defect controlled nanotubes according to the present invention can be made in any manner. For example, the tubes can be produced in a process that provides a desired quantity and quality of defects. The defect controlled nanotubes are preferably produced by treating previously produced nanotubes to have the controlled density and/or type of defects according to the present invention, such as by treating no-defect or low-defect nanotubes. For example, a process for creating a defect controlled nanotube can include growing the nanotubes in bundles to assure a reasonable yield of desired density and/or type of defect between selected points. For example, in certain applications positioning of the nanotube might be important. Thus, for example, in the case of a mechanical sensor, nanotubes are placed where deformation of the base structure is largest. Therefore nanotubes are grown between two pre-determined points on the base film.

During a typical production of a bundle of nanotubes, such as by chemical vapor deposition, the bundle of nanotubes can contain 10 or more nanotubes with a combined, parallel resistance ranging from several kilo-ohms to 10 s of kilo-ohms, such as up to 100 kohms. As noted above, a single carbon nanotube produced by typical processes usually has a resistance in the order of about 6 kilo-ohms to 12 kilo-ohms, and is exemplary of nanotubes that are of good quality with few unintended defects and good metallic contacts. Therefore, when nanotubes are subjected to treatment to induce defects to provide the defect controlled nanotubes of the present invention, the starting nanotubes have at most a small number of defects, have random defects, and are random as to the type of defect.

Defects can be induced in the nanotubes by treating the nanotubes in any manner that provides the controlled formation of density and/or type of defects in the nanotube according to the present invention. For example, and without limitation, the nanotubes can be treated with electromagnetic radiation. The electromagnetic radiation can be provided by UV lamps which irradiate the nanotubes. The UV lamps preferably have emission wavelengths ranging from about 250 nm to 370 nm. In fact, shorter wavelengths can be utilized which produce photons of higher energy. Power output of a general purpose lamp is about 10-20 mW/sq.cm. It is desirable to place the nanotubes in close proximity to the lamp, for example a few mm, since power density decreases with increasing distance from the lamp. The nanotubes can be irradiated for a period of time depending upon the density and type of defect desired, such as several minutes. For example, and without limitation, the radiation can be applied for about 5 to 20 minutes. Still further, the radiation can be applied continuously, or can be applied intermittently.

Moreover, as noted above, it is possible to radiate the nanotube, such as continuously, while checking the defect density, for example by means of resistance, preferably continuously as well. For example, starting with a nanotube bundle of several kilo-ohms resistance, one can target a final resistance greater than 100 kil-ohms after introducing defects. This would typically take a radiation time of about 10 minutes using UV radiation of about 250 nm to 370 nm positioned within 1 mm of the nanotubes for producing broken bond defects which defects have a characteristic energy to break the bond of about 5 eV.

The production of different types of defects can include the application of differing quantities of energy. For example, lower energy, such as UV radiation, is needed for breaking of bonds than changing bonds from sp2 to sp3, which needs less energy than changing a six-membered ring to a five-membered ring.

There are a number of design parameters that can be varied with respect to producing sensors of defect controlled nanotubes. These parameters include nanotube parameters and defect parameters. Nanotube parameters include, without limitation, material of composition of the nanotube, such as the backbone atom which is preferably carbon, nanotube diameter, nanotube length, and electrical characteristics if the nanotube, such as being conductive or semiconductive. Defect parameters include, without limitation, defect density, defect type, for example, broken bond, 5-vs. 6-membered ring, energy of defect formation, and after treatment, for example, stabilization of the bond, such as with hydrogen.

Examples of defect controlled nanotube sensor implementation include mechanical sensors, temperature sensors, light sensors and humidity sensors.

Mechanical sensors can include carbon nanotubes of high aspect ratio, for example, greater than about 10, more preferably greater than about 100, having broken and stabilized bonds, and having a high density of defects to provide resistances according to the present invention without compromising the integrity of the nanotube at maximum strain. At least the nanotube can include a protection layer, such as, composed of polymethylmethacrylate (PMMA) polymer, to prevent exposure to ambient gases. Moreover, at least the nanotube can be placed in an opaque housing to prevent exposure to light. The nanotube can be semi-metallic, semiconductive or conductive. For example, with respect to carbon nanotubes, the nanotubes can be, for examples, semiconductive with a bandgap of about 0.5 eV at about 1.5 nm diameter, semi-metallic with a bandgap small as compared with room temperature energy of 26 milli-eV (at room temperature many electrons can jump to the conduction band), and conductive with no bandgap.

Temperature sensors can include semi-metallic type nanotubes, preferably of carbon, of high aspect ratio, for example, greater than about 10, more preferably greater than about 100, having broken and stabilized bonds, and a density of defects adjusted to broaden the bandgap to several times, for example, 5 times that of thermal energy corresponding to the temperature of interest. At least the nanotube can include a protection layer with high thermal conductivity to prevent exposure to light. Moreover, at least the nanotube can be placed in an opaque housing to prevent exposure to light.

Light sensors can include nanotubes, preferably of carbon, of small diameter, for example, less than 1 nm, and having a low aspect ratio, for example, less than 10 having broken and stabilized bonds, and a density of defects adjusted to obtain a bandgap which corresponds to the energy of the photons at the wavelength of interest. At least the nanotube can include a transparent protection layer to prevent exposure to ambient gases. Moreover, the transparent housing allows passage of electromagnetic radiation at the wavelength of interest to be detected.

Humidity sensors can include nanotubes, preferably of carbon, of high aspect ratio, for example, greater than about 10, more preferably greater than about 100, having broken and stabilized bonds, and a high density of defects without compromising the integrity of the nanotube. At least the nanotube can be include an opaque housing to prevent exposure to light. However, the housing must be permeable to water molecules in the ambient atmosphere. For example, the housing can be constructed of a material which is opaque to light and permeable to humidity, such as but not limited to an apertured, opaque enclosure.

Still further, the nanotubes of the present invention can have varying application, such as without limitation as light emission devices However, the defect controlled nanotubes are preferably used as sensors. For example, the bandgap of long (about several 100 nm) conductive nanotubes is nearly zero, but the bandgap of short (about 1 nm) conductive nanotubes is large (about 2 eV). Thus, use semiconductive nanotubes and conductive nanotubes may be useful as light emitter devices. In any event, as noted above, introduction of defects gives rise to a significant change in the bandgap of conductive nanotubes, and this phenomenon can be used to adjust the emission wavelength. An alternating electric field as a non-contact electrical excitation method can be used to achieve such light emission. Still further, optical excitation, for example, a UV LED can be considered as an alternate, non-contact excitation method. In that case the nanotube serves as a nano scale phosphor rather than as a light emitting device by generating light emission at a different wavelength.

Without further elaboration, it is believed that one skilled in the art can, using the preceding description, utilize the present invention to its fullest extent.

The following preferred specific embodiments are, therefore, to be construed as merely illustrative, and not limitative of the remainder of the disclosure in any way whatsoever.

### EXAMPLES

### Example 1

Nanotube models are based upon nanotubes about 1 nm long, and diameters of about 0.5 nm. The models are relatively small as compared to average actual carbon nanotubes but are representative. Computing power needed for atomic level simulations grows very rapidly with the number of atoms, therefore there are limitations with regard to the size of the model.

Nanotube simulations are carried out by using a software called HyperChem, from HyperCube; Inc, Gainesville, Fla., which is a typical molecular modeling software used in Quantum Chemistry. HyperChem includes a graphical user interface which is used to draw the model. Atoms forming the backbone of the nanotube are entered by mouse clicks. Typically, one would enter the nanotube as a 2 dimensional planar object, then joins the ends that roll into a tube and finally use the model building feature of the software to adjust the bond lengths and bond angles. It is generally recommended to further optimize the geometry by using one of the calculation methods provided in the software. Geometry optimizations were performed using Molecular Mechanics method.

Out of the many possible variations of carbon nanotube structure, two types are chosen as representative models: 1) Semiconductive type of zigzag nanotube which contains 5 rings (6 member hexagons) in the circumference, also indicated traditionally by indices (5, 0). It has a diameter of about 0.4 nm. 2) Conductive type of zigzag nanotube which contains 6 rings in the circumference, also indicated by indices (6, 0). It has a diameter of about 0.5 nm. Both nanotubes have a length of about 1 nm. Incomplete bonds at the endpoints of the nanotubes are completed (passivated) by adding hydrogen atoms.

Properties of the nanotube, for example bandgap, are calculated using Semi Empirical Austin AM1 method. HyperChem has a feature where electric field can be applied to the model being simulated. Polarizability of the nanotube is calculated by applying electric field in various directions, for example parallel to the nanotube axis or parallel to the diameter direction (perpendicular to the axis).

### Example 2

Defects can be introduced into semiconductive and conductive carbon nanotubes, and a simulation of introducing defects can be prepared by modifying the models of carbon nanotubes without defects.

In order to simulate a broken carbon-carbon bond of a carbon nanotube, a bond of a 6-membered ring was broken at one location and hydrogen is attached to the dangling bonds. After introducing the defect, Molecular Mechanics method is used to optimize the geometry around the defect.

Results:

| Semiconductive nanotube | No defect | | With defect | | Change |
|---|---|---|---|---|---|
| Bandgap | 3.84 | eV | 3.77 | eV | −2% |
| Axial polarizability | 2300 | au | 2660 | au | +16% |
| Radial polarizability | 1670 | au | 1980 | au | +19% |
| Conductive nanotube | | | | | |
| Bandgap | 2.07 | eV | 2.65 | eV | +28% |
| Axial polarizability | 3530 | au | 4020 | au | +14% |
| Radial polarizability | 1650 | au | 1710 | au | +4% |

Defects especially change the properties of the conductive nanotube and the bandgap becomes bigger (conductance decreases). As discussed above, it is also possible to introduce defects during the growth process of the nanotube; in which case relatively higher resistance can be expected.

### Example 3

Recently it has been noted that the bandgap of boron nitride nanotube varies with electric field, and similar results have been observed during simulations with carbon nanotubes. Therefore, this example is a simulation in more detail of the variation of bandgap as a function of the applied electric field.

Semiconductive nanotubes (diameter: 0.4 nm, length: 1.1 nm, number of 6 member rings included in the circumference: 5) and conductive nanotube (diameter: 0.5 nm, length: 1.1 nm, number of 6 member rings included in the circumference: 6) are used in this stimulation. An electric field is applied along the axial direction and the diameter direction and allowed energy levels and bandgap are calculated. Simulation results are shown in FIG. 15.

Results are as follows:
The bandgap of both types of nanotubes varies considerably with electric field; the magnitude of variation reaches several eV.
With increasing electric field, the bandgap of semiconductive nanotube decreases and that of conductive nanotube increases. The range of variation pertaining to the semiconductive nanotube is comparatively greater.
The variation due to the electric field in axial direction is relatively greater than that due to electric field in diameter direction.
Those properties which have close connection to the bandgap, for example electric properties or optical properties, can be controlled over a wide range by using this phenomena. For example wavelength of the carbon nanotube light emitter can be controlled by means of an electric field. Results given in FIG. 15 indicate that the bandgap changes from about 1.9 eV (650 nm) to about 3.0 eV (320 nm), therefore it means that almost all visible wavelengths can be emitted.

The preceding examples can be repeated with similar success by substituting the generically and specifically described constituents and/or operating conditions of this invention for those used in the preceding examples. From the foregoing descriptions, one skilled in the art can easily ascertain the essential characteristics of this invention, and without departing from the spirit and scope thereof, can make various changes and modifications of the invention to adapt to various usages and conditions.

1. A sensor for detecting at least one of a physical and chemical quantity, comprising a defect controlled nanotube providing a change in electrical characteristic responsive to at least one of a physical and chemical quantity.

2. The sensor of claim 1 comprising a circuit containing the defect controlled nanotube as a resistive device, said defect controlled nanotube being included in the circuit so that change of resistive properties of the resistive device is related to the change in electrical characteristic responsive to at least one of a physical and chemical quantity.

3. The sensor of claim 1 comprising a circuit containing the defect controlled nanotube as a capacitive device, said defect controlled nanotube being included in the circuit so that change of capacitive properties of the capacitive device is related to the change in electrical characteristic responsive to at least one of a physical and chemical quantity.

4. The sensor of claim 1 comprising a circuit containing the defect controlled nanotube as a transistor device, said defect controlled nanotube being included in the circuit so that change of drain to source conductance of the transistor device is related to the change in electrical characteristic responsive to at least one of a physical and chemical quantity.

5. The sensor of claim 3 wherein the capacitor is constructed with each electrode spaced from the defect controlled nanotube, and said defect controlled nanotube is included in the circuit as a polarizable material.

6. The sensor according to claim 5 wherein the circuit is constructed and arranged to apply an electric field parallel or perpendicular to the nanotube.

7. The sensor according to claim 1 wherein the sensor is capable of detecting at least one of humidity, light, temperature and strain.

8. The sensor according to claim 1 wherein the sensor comprises a deformation sensor, the defect controlled nanotube being associated and deformable with a deformable support.

9. The sensor according to claim 1 wherein the defect controlled nanotube comprises a nanotube having a length of at least 1 μm, and comprises at least one section along the length of the nanotube that has a density of defects of at least 2 defects per 100 nm.

10. The sensor according to claim 1 wherein the defect controlled nanotube comprises a nanotube having a length of at least 1 μm, and comprises at least one section along the length of the nanotube that has a density of defects of at least 2 defects per 10 nm.

11. The sensor according to claim 1 wherein the defect controlled nanotube comprises a nanotube having a length of at least 1 μm, and comprises at least one section along the length of the nanotube that has a density of defects of at least 2 defects per 1 nm.

12. The sensor according to claim 10 wherein the defect controlled nanotube comprises a nanotube having a length of at least 1 μm, and comprises at least 50 defects along at least one 1 μm length of the nanotube.

13. The sensor according to claim 1 wherein the defect controlled nanotube comprises a nanotube having a length of at least 1 μm, and comprises at least 100 defects along at least one 1 μm length of the nanotube.

14. The sensor according to claim 1 wherein the defect controlled nanotube comprises a nanotube having a length of at least 1 μm, and comprises at least 500 defects along at least one 1 μm length of the nanotube.

15. The sensor according to claim 1 wherein the defect controlled nanotube has a length less than 1 μm, and a 30% section, when normalized to a 1 μm section, comprises at least 50 defects.

16. The sensor according to claim 12 wherein the at least one 1 μm length of the nanotube comprises substantially any 1 μm length of the nanotube.

17. The sensor according to claim 1 wherein the defect controlled nanotube comprises a nanotube having a length of at least 1 μm, and the defect controlled nanotube includes one type of defect along at least one 1 μm section of the nanotube at a number of at least 5 times an average number of other defects in a same section of the nanotube.

18. The sensor according to claim 1 wherein the defect controlled nanotube comprises a nanotube having a length of at least 1 μm, and the defect controlled nanotube includes one type of defect along at least one 1 μm section of the nanotube at a number of at least 100 times an average number of other defects in a same section of the nanotube.

19. The sensor according to claim 12 wherein the defect controlled nanotube comprises a nanotube having a length of at least 1 μm, and the defect controlled nanotube includes one type of defect along at least one 1 μm section of the nanotube at a density of at least 100 times an average number of other defects in a same section of the nanotube.

20. The sensor according to claim 1 wherein the defect controlled nanotube comprises a nanotube having a length of less than 1 μm, and the defect controlled nanotube includes one type of defect along at least one 30% section of the nanotube at a density of at least 5 times an average number of other defects in a same section of the nanotube.

21. The sensor according to claim 1 wherein the defect controlled nanotube comprises a nanotube having a length of less than 1 μm, and the defect controlled nanotube includes one type of defect along at least one 30% section of the nanotube at a number of at least 100 times an average number of other defects in a same section of the nanotube.

22. The sensor according to claim 15 wherein the defect controlled nanotube comprises a nanotube having a length of less than 1 μm, and the defect controlled nanotube includes one type of defect along at least one 30% section of the nanotube at a number of at least 5 times an average number of other defects in a same section of the nanotube.

23. The sensor according to claim 1 having a measurable response when the nanotube is subjected to a strain of 0.01%.

24. The sensor according to claim 23 wherein the sensor has a gauge factor of at least 100 when the nanotube is subjected to a strain of 0.01%.

25. The sensor according to claim 1 wherein the defect controlled nanotube comprises a post treated nanotube, and the sensor has an increased sensitivity compared to a sensor only being different in that a nanotube included therein is not post treated.

26. The sensor according to claim 25 wherein the sensor has a gauge factor of at least 100 when the nanotube is subjected to a strain of 0.01%.

27. The sensor according to claim 1 including electrodes, and said defect controlled nanotube is spaced from at least one of said electrodes.

28. The sensor according to claim 1 including electrodes, and said defect controlled nanotube is spaced from each of the electrodes.

29. A sensor for detecting at least one of a physical and chemical quantity, comprising at least one post treated nanotube modified with sufficient energy to modify at least one of density and type of defects in the nanotube, and said nanotube being associated with a circuit capable of providing an output signal based upon change of electrical characteristic of said nanotube in response to stimulus of the nanotube by at least one of a physical and chemical quantity.

30. A method of producing a sensor comprising post treating a nanotube with sufficient energy to modify at least one of density and type of defects in the nanotube, and associating the nanotube with a circuit capable of providing an output signal based upon change of electrical characteristic of the nanotube in response to stimulus of the nanotube.

31. The method according to claim 30 wherein the sensor is capable of detecting at least one of humidity, light, temperature and strain.

32. The method according to claim 30 wherein the post treatment comprises treatment with electromagnetic radiation.

33. The method according to claim 30 wherein the post treatment comprises treatment with UV radiation.

34. A sensor produced by the method of claim 30.
